(19) United States
(12) Patent Application Publication
(10) Pub. No.: US 2024/0157764 A1
(43) Pub. Date: May 16, 2024

(54) BELT WITH HEATING SECTION AND TEMPERATURE MEASURING DEVICE, AND SEAT BELT SYSTEM

(71) Applicant: ZF AUTOMOTIVE GERMANY GMBH, Alfdorf (DE)

(72) Inventors: Viktorija MECNIKA, Schwabisch Gm¿nd (DE); Martina RAUSCH, Remshalden (DE)

(21) Appl. No.: 18/550,299

(22) PCT Filed: Mar. 15, 2022
(86) PCT No.: PCT/EP2022/056629

§ 371 Date: Sep. 13, 2023

(30) Foreign Application Priority Data
Mar. 16, 2021 (DE) 10 2021 106 308.6

(51) Int. Cl. B60H 1/22; B60R 22/12; G01K 1/14; G05D 23/20; H05B 3/34

(52) U.S. Cl. CPC B60H 1/2218; B60R 22/12; G01K 1/14; G05D 23/20; H05B 3/347

(57) ABSTRACT

The invention describes a belt retractor (10) for a vehicle including a locking disk (22) on which a locking element (24) is supported. In an extended position, the locking element (24) engages in locking teeth (28) on a frame (12) of the belt retractor (10). In a retracted position, the locking element (24) releases the locking teeth (28). There is further provided a clutch disk (38) which is motion-coupled with the locking element (24) via a control geometry (40) and a control element (36). The control geometry (40) comprises a first retraction area as well as a second retraction area for receiving the control element (36) in an at least partially retracted position of the locking element (36) and a first extension area as well as a second extension area for receiving the control element (36) in the extended position of the locking element (24). The invention further presents a method for releasing a mis-synchronized locking position of a belt retractor (10).

The invention relates to a belt retractor for a vehicle, comprising a frame in which a belt reel for winding and unwinding a belt webbing is rotatably supported about a belt reel axis. Moreover, a locking disk is provided which is coupled with the belt reel. On the locking disk a locking element is supported which, in an extended position, engages in locking teeth on the frame to lock the locking disk with respect to rotation relative to the frame. In a retracted position, the locking element releases the locking teeth on the frame to enable the locking disk to rotate relative to the frame. Moreover, the belt retractor comprises a clutch disk which is rotatably supported about the belt reel axis to a limited extent and is coupled with the locking element via a control geometry as well as a control element cooperating with the control geometry so that, by rotation of the clutch disk relative to the locking disk, the locking element can be shifted between the extended position and the retracted position. Equally, the belt retractor comprises a locking pawl which is adjustable between a blocking position in which it engages in blocking teeth on the clutch disk to block the clutch disk against rotation in an unwinding direction relative to the frame, and an idle position in which it does not engage in the blocking teeth so that unhindered rotation of the clutch disk relative to the frame is possible. The control geometry has a first retraction area to receive the control element in the retracted position of the locking element and a first extension area to receive the control element in the extended position of the locking element, when the clutch disk and the locking disk are rotated against each other within a predefined degree.

In addition, the invention relates to a method for releasing a mis-synchronized locking position of a belt retractor comprising a belt reel for winding and unwinding a belt webbing and a locking disk coupled to the belt reel on which a locking element is supported which in an extended position engages in locking teeth on a frame to lock the locking disk with respect to rotation relative to the frame. Accordingly, the belt retractor moreover includes a blocking pawl which in a blocking position engages in blocking teeth on a clutch disk which is motion-coupled with the locking element to block the coupling disk with respect to rotation relative to the frame. Specifically, the belt retractor is a belt retractor of the type mentioned in the beginning.

For better legibility, hereinafter the term “locking” is used with reference to the rotary stop of the locking disk relative to the frame. In contrast to this, the term “blocking” is used when the rotary stop of the clutch disk with reference to the frame is concerned. In respect of the belt retractor on the whole, both terms are used.

Those belt retractors are known from prior art.

The locking element and the blocking pawl serve to suppress, i.e., to block or to lock, unwinding of the belt webbing from the belt retractor in a vehicle-sensitive manner, that is, in response to a state, specifically a deceleration of the vehicle in which the belt retractor is installed, and/or in a webbing-sensitive manner, that is, in response to a state of the webbing, specifically an extension acceleration or extension velocity.

As already explained before, the locking element which can lock rotation of the locking disk and, thus, the belt reel relative to the frame is actuated via rotation of the clutch disk relative to the locking disk, i.e., is particularly shifted to its extended position. For this purpose, the locking disk and the clutch disk must be rotatably supported adjacent to each other. Further, the clutch disk and the locking disk are coupled via the control element, the control geometry and the locking element supported on the locking disk.

In this way, a vehicle occupant can always be retained safely inside the vehicle by means of the belt webbing. This applies specifically to the case that the vehicle in which the belt retractor is installed is involved in an accident.

The control geometry is configured as a control cam or gate and the control element is configured as a control pin.

In this context, a degree of mobility of the control element relative to the control geometry results from the geometrical design of the control element and the control geometry. Taking the movable support of the locking element on the locking disk into account, a predefined degree of relative rotatability of the clutch disk vis-à-vis the locking disk results therefrom. Such relative rotatability is thus limited in both directions of rotation because of the afore-explained coupling mechanism.

The predefined degree of relative rotatability of the clutch disk vis-à-vis the locking disk causes, in a situation in which the clutch disk is rotationally blocked by means of the blocking pawl and the locking disk is rotated relative to the clutch disk by unwinding the webbing, said rotation to exist only until the locking element is transferred to its extended position by means of the control geometry and the control element and engages in a predefined portion or a predefined tooth of the locking teeth on the frame. The predefined portion or tooth represents a result of design which is obtained based on each possible rotary position of the locking element, if the clutch disk is rotationally arrested, by adding the relative rotation between the clutch disk and the locking disk required for shifting the locking element. Hence, for each rotary position of the locking element on the locking disk in which it is possible to block the clutch disk, a tooth or a portion of the locking teeth can be determined in which the locking element engages to rotationally block the locking disk. Due to this fact, this is also referred to as synchronized locking or synchronized blocking of the belt retractor. Also, such a state of the belt retractor can be referred to as locking state or locking position.

When a state that requires locking of the locking disk and, thus, blocking of further unwinding of the webbing is ended, the locking element can be disengaged from the locking teeth again by returning the locking disk relative to the clutch disk. In addition, the blocking disk is disengaged from the blocking teeth. Thus, webbing can be reeled and unreeled again by means of the belt retractor.

For rotationally blocking and subsequently releasing the belt reel relative to the frame, consequently plural component parts of the belt retractor must cooperate. Specifically, the blocking pawl, the clutch disk, the locking disk, the locking element, the control element and the control geometry must be precisely matched.

In particular, those component parts must cooperate reliably irrespective of dynamics by which the belt retractor is activated. This must be ensured over a wide range of operating temperatures and throughout the entire life cycle of the belt retractor, i.e., irrespective of possible occurrence of aging.

Accordingly, the belt retractor must be prevented from assuming a blocking state deviating from synchronized blocking. Those blocking states are referred to as mis-synchronized or non-synchronized and result in component parts of the belt retractor jamming in an undesired manner and, thus, impairing the function thereof.

It is obvious that this requires a certain effort when designing and manufacturing the belt retractor.

Consequently, it is the object of the invention to provide a belt retractor of the type mentioned in the beginning which can be manufactured and designed with little effort. The belt retractor is intended to be at least equivalent to known belt retractors as regards its function.

The object is achieved by a belt retractor of the type mentioned in the beginning in which the control geometry includes a second extension area to receive the control element in the extended position of the locking element, if the clutch disk and the locking disk are rotated against each other beyond the predefined degree. In addition, the control geometry of the belt retractor according to the invention includes a second retraction area to receive the control element in a partially retracted position of the locking element. Accordingly, the second extension area and the second retraction area are separate from each other as well as separate from the first extension area and from the first retraction area.

Beyond the known prior art, the control geometry and, thus, the belt retractor as a whole, is explicitly designed also for states in which the locking disk and the coupling disk are rotated against each other beyond the predefined degree. In other words, the clutch disk and the locking disk are allowed to be over-rotated relative to each other. Based on the rotational blocking of the clutch disk by means of the blocking pawl, which may occur in any rotary position of the locking element, the locking element then does no longer engage in the predetermined tooth or portion of the locking teeth on the frame, but in a tooth or portion deviating therefrom. Then the belt retractor is locked in a mis-synchronized or mis-associated state.

Such a locking state may occur, for example, under the influence of high temperatures, high activating velocities of the moved elements of the belt retractor or under the influence of play within the blocking and/or locking mechanism of the belt retractor.

As, according to the invention, a second retraction area of the control geometry is provided, the belt retractor can be transferred from the mis-synchronized state, i.e., from the state in which the belt reel is prevented from rotating, but the clutch disk and the locking disk are rotated against each other beyond the predefined degree, reliably to an operating state again in which webbing can be reeled and unreeled. In other words, the invention ensures that the belt retractor can leave such a mis-synchronized state again.

In known belt retractors, such a mis-synchronized locking state is undesired and usually results in jamming of the belt retractor so that the latter cannot be transferred from the locking state to a state any more in which reeling and/or unreeling of the webbing is possible.

On the one hand, the belt retractor according to the invention thus has a simple design. Furthermore, it is robust in respect of assuming a mis-synchronized state. Consequently, it exhibits increased reliability in operation as compared to known belt retractors.

In the belt retractor according to the invention, the control geometry and the control element serve to motion-couple the locking element and the clutch disk. However, this does not imply that the control geometry and the control element are in contact with each other at any time.

The locking element may be designed as a locking slide which is movably supported on the locking disk specifically along a direction extending transversely to the belt reel axis. As an alternative, the locking element may be a locking pawl which is rotatably supported on the locking disk specifically about an axis of rotation. Accordingly, specifically the axis of rotation of the locking pawl is oriented substantially in parallel to the belt reel axis.

According to one embodiment, the second extension area is positioned on a side of the first extension area opposite to the first retraction area. The second extension area is thus also positioned adjacent to the first extension area. In this way, it is ensured that the control element can be reliably transferred to the second extension area and the belt retractor can thus assume the mis-synchronized or over-rotated state.

Moreover, the second retraction area is positioned specifically on a side of the second extension area opposite to the first extension area. The second retraction area is assumed by the control element, if the belt retractor is intended to leave a mis-synchronized position again. As, thus, the second retraction area is disposed next to the second extension area, this is possible in a quick and easy manner. Hence, the belt retractor can reliably leave the mis-synchronized locking state.

In a variant, furthermore the first retraction area and the second retraction area are disposed at opposite ends of the control geometry.

Consequently, as a whole, the following arrangement of the different areas along the control geometry is resulting: second retraction area, second extension area, first extension area, first retraction area.

Such a control geometry has a simple and compact structural design. In this way, it can be manufactured comparatively easily and can be reliably operated.

The control geometry may be substantially curved. In particular, the ends of the control geometry are facing the belt reel axis. Such a control geometry can be disposed inside the belt retractor in a space-saving manner. Moreover, it can be manufactured by standard tools and machines.

Also, such a control geometry can be referred to as kidney-shaped or banana-shaped.

According to one alternative, the control geometry is formed by a portion of an opening or a recess. Specifically, the control geometry is an edge portion of the opening or recess. Such a control geometry can be easily manufactured. Moreover, it is robust in operation.

The control element may be formed by a control pin. Such a control element can interact with a control geometry formed by a portion of an opening or recess in a reliable manner. Moreover, a control pin has a simple and robust structure.

Preferably, in this context the opening or recess is provided on the clutch disk and the control pin is formed on the locking element. Thus, a reliable motion-coupling of the clutch disk and the locking element is formed, with a relative rotation between the clutch disk and the locking disk resulting in shifting of the locking element relative to the locking disk. Said shifting is performed, depending on the sign of the relative rotation, in the direction of the extended position or in the direction of the retracted position of the locking element. An angle of rotation of the clutch disk vis-à-vis the locking disk determines the degree of shifting.

The blocking pawl can be drivingly coupled with an actuator by means of which the blocking pawl can be transferred at least from the idle position to the blocking position. In so doing, the actuator can operate in a vehicle-sensitive and/or a webbing-sensitive manner. The blocking pawl can be transferred from the blocking position to the idle position solely by the force of gravity acting on the blocking pawl. The transfer of the blocking pawl to the idle position is thus performed so-to-speak passively. As a result, the structure of the belt retractor is simple.

The blocking pawl can also be used as webbing-sensitive actuator, for which purpose it is supported on the clutch disk, for example.

Further, the locking element can be biased vis-à-vis the locking disk in its retracted position. Specifically, the locking element is biased vis-à-vis the locking disk by a spring. Thus, there is always a defined position of the locking element relative to the locking disk. In addition, noise and vibrations are damped in this way.

The clutch disk may further be biased vis-à-vis the locking disk in an initial rotary position. The clutch disk is specifically biased into the initial rotary position by means of a spring. The clutch disk can be adjacent to a contact face of the locking disk in the initial rotary position. Hence, even in this context, there is always a defined rotary position. Also, undesired noise and vibrations are avoided. Moreover, rotation of the clutch disk relative to the locking disk can be restricted by a further stop.

In addition, the control element may be biased, at least if it is disposed in the second extension area, in the direction of the control geometry. In this context, too, the bias results particularly from a spring. The control element thus interacts, at least if it is disposed in the second extension area, with the control geometry in a defined way.

Such a spring may be integral with the clutch disk or may be a separate component part mounted on the clutch disk. The spring can be made of a metallic or plastic material.

The object is additionally achieved by a method of the type mentioned in the beginning comprising the following steps of:
rotating the belt reel in an unwinding direction, the locking element sliding off at least one tooth back of the locking teeth on the frame and being shifted in the direction of its retracted position, and
releasing the blocking pawl so that it is transferred from the blocking position to an idle position in which it releases a rotation of the clutch disk relative to the frame.

The mis-synchronized locking position can thus be released by rotating the belt reel initially in the winding direction. In this way, the blocking pawl is disengaged from the blocking teeth. Based on this, no more mis-synchronized locking position is provided so that the belt retractor can be easily removed from said locking position.

Therefore, even in the method according to the invention, a mis-synchronized locking position of the belt retractor is explicitly admitted and, at the same time, there is defined a way how the belt retractor can leave said locking position again. This results in an increased reliability during operation of the belt retractor.

According to one variant, the blocking pawl is released by a rotary motion of the clutch disk in the winding direction. Such rotary motion particularly results from the locking element which is moved within the scope of step a) being motion-coupled with the clutch disk. The blocking pawl is thus reliably released.

The locking element can moreover be transferred, after releasing the blocking pawl by rotating the belt reel in the unwinding direction, to an extended position corresponding to a synchronized locking state. Based on this, the belt retractor can be transferred to its operating state again in which webbing can be smoothly wound and unwound. The mis-synchronized locking state is thus quickly and reliably canceled.

The method is carried out in particular by means of the belt retractor according to the invention.

In the following, the invention shall be illustrated by means of an embodiment shown in the attached drawings, wherein:

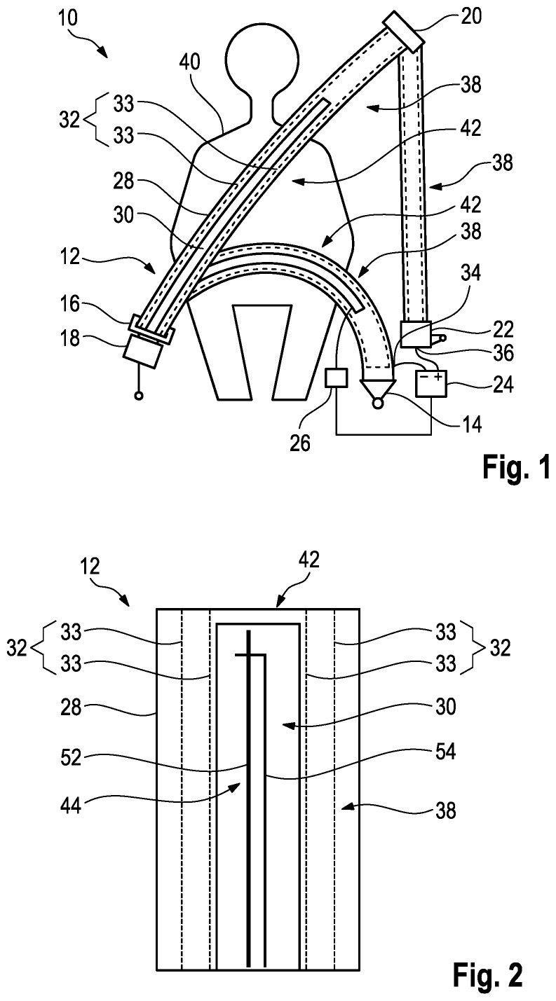

FIG. 1 schematically shows a belt retractor according to the invention by means of which a method according to the invention can be carried out,

each of FIGS. 2 to 16 shows detail views of the belt retractor of FIG. 1 during a sequence of the method according to the invention,

FIG. 17 shows a control geometry and a cooperating control element of the belt retractor of FIGS. 1 to 16 in an isolated representation, and

FIGS. 18 to 20 show different variants to design a spring on a clutch disk of the belt retractor according to the invention.

FIG. 1 illustrates a belt retractor 10 for a vehicle.

The belt retractor 10 comprises a frame 12 on which a belt reel 14 for winding and unwinding a belt webbing 16 is mounted.

More precisely, the belt reel 14 is supported rotatably about a belt reel axis 18 in the frame 12.

The belt retractor 10 moreover includes a fastener 20 via which it can be fastened in the automotive vehicle.

Unwinding the webbing 16 from the belt reel 14 can be locked or blocked specifically in a vehicle-sensitive manner, i.e., in response to a state of the vehicle in which the belt retractor 10 is mounted, and/or in a webbing-sensitive manner, i.e., in response to a state of the belt webbing 16.

In said locked or blocked state of the belt retractor 10, the webbing 16 is prevented from being further unwound from the belt reel 14.

In order to provide this functionality, a locking disk 22 is coupled with the belt reel 14.

On the locking disk 22 a locking element 24 is supported which in the shown embodiment is in the form of a locking slide that is movable relative to the locking disk along a direction 26 extending substantially transversely to the belt reel axis 18 (see FIG. 1).

Therefore, in the following the reference numeral 24 is used both for the locking slide and for the locking element.

The locking slide 24 in this context can assume an extended position in which it engages in locking teeth 28 on the frame 12 and, thus, locks the locking disk 22 with respect to a rotation relative to the frame 12.

This applies particularly in a direction of rotation symbolized by the arrow 30 which corresponds to the unwinding of the belt webbing 16.

The locking slide 24 may also assume a retracted position. In said position, it releases the locking teeth 28 on the frame 12, thereby enabling rotation of the locking disk 22 relative to the frame 12.

The locking slide 24 is moreover biased in the direction of its retracted position by means of a spring 32. More precisely, said bias results from a portion 34 of the spring 32.

Further, on the locking slide 24 a control element 36 in the form of a control pin is disposed, whose function shall be explained further below.

Moreover, the belt retractor 10 comprises a clutch disk 38 which is rotatable about the belt reel axis 18 to a limited extent.

More precisely, the clutch disk 38 is rotatable between the stops 39a, 39b of the locking disk 22 relative to the latter.

On the clutch disk 38 there is also provided a control geometry 40 which in the shown embodiment is in the form of an edge portion 42 of an opening 44 of the clutch disk 38.

It is understood that, in the FIGS. 2 to 16, the clutch disk 38 is illustrated to be broken so that the component parts lying behind it, specifically the locking slide 24 and the locking disk 22, are visible. In reality, the periphery of the clutch disk 38 is closed.

For these reasons, the opening 44 which is thus delimited all over by the clutch disk 38 is shown in the FIGS. 2 to 16 in portions by a free-floating contour.

The control geometry 40 cooperates with the control element 36 provided on the locking slide 24.

In this way, the locking slide 24 can be displaced by rotation of the clutch disk 38 relative to the locking disk 22 between its extended position and its retracted position. This applies both to a displacement in the direction of the retracted position and to a displacement in the direction of the extended position.

The control geometry 40 can also be referred to as control gate. The control element 36 then constitutes a sliding block.

The control geometry 40 is substantially curved, the ends of the control geometry 40 facing the belt reel axis 18.

The control geometry 40 moreover comprises different areas (see FIG. 17) in which the control element 36 may be arranged in response to a rotary position of the clutch disk 38 relative to the locking disk 22.

Based on the end of the control geometry 40 shown on the right in the Figures, the control geometry 40 comprises a first retraction area 40a in which the control element 36 may be received in the retracted position of the locking element 24.

Moreover, the control geometry comprises a first extension area 40b which is equally configured to receive the control element 36. The control element is provided in the first extension area, however, if it assumes its extended position and the clutch disk 38 is rotated relative to the locking disk 22 within a predefined degree, as shall be explained further below.

The control geometry 40 moreover includes a second extension area 40c that can receive the control element 36 in the extended position of the locking element, if the clutch disk 38 and the locking disk 22 are rotated against each other beyond the predefined degree.

Further, a second retraction area 40d is provided for receiving the control element 36 in a partially retracted position of the locking element 24.

Thus, the second extension area 40c is located on a side of the first extension area 40b opposite to the first retraction area 40a.

The second retraction area 40d is positioned on a side of the second extension area 40c opposite to the first extension area 40b.

The first retraction area 40a and the second retraction area 40d are disposed at opposite ends of the control geometry 40.

In this context, the clutch disk 38 is spring-loaded vis-à-vis the locking disk 22 (spring is not shown).

Blocking teeth 46 are additionally provided on the clutch disk 38.

Further, the belt retractor 10 has a blocking pawl 48 which in the shown embodiment is rotatably supported on the frame 12.

The blocking pawl 48 may assume a blocking position in which it engages in the blocking teeth 46 to block the clutch disk 38 against rotation in an unwinding direction (see arrow 30).

Alternatively, the blocking pawl 48 may assume an idle position in which it does not engage in the blocking teeth 46 and consequently enables unhindered rotation of the clutch disk 38 relative to the frame 12.

In this context, the blocking pawl 48 is drivingly coupled with a merely schematically shown actuator 50 by means of which the blocking pawl 48 can be transferred from the idle position to the blocking position.

The actuator 50 can actuate the blocking pawl 48 in a vehicle-sensitive and/or webbing-sensitive manner.

On the belt retractor 10 moreover a spring 52 is provided by means of which the control element 36 is biased, as least if it is disposed in the second extension area 40c, in the direction of the control geometry 40.

To this end, the spring 52 is fastened to the clutch disk 38.

As an alternative to the spring 52, a portion 54 of the spring 32 may be provided for this purpose.

Thus, it is understood that the spring 52 and the portion 54 of the spring 32 are alternatives which are shown inside the same belt retractor 10 for ease of illustration, however.

In reality, either the spring 52 or the portion 54 of the spring 32 is provided.

In the alternative in which the spring 52 is provided, the latter may be formed as a separate spring element that is fastened to the clutch disk 38 (see FIG. 18).

In this context, the spring 52 is preferably made of a metal, whereas the clutch disk is made of a plastic material.

Also, it is possible to design the spring 52 integrally with the clutch disk 38 (see FIGS. 19 and 20). In that case, the spring 52 and the clutch disk 38 are made of the same material, specifically of a plastic material.

In the following, the function of the belt retractor shall be explained.

The blocking pawl 48 initially is in its idle position and the locking slide 24 is in its retracted position.

Consequently, the belt reel 14 is freely rotatable about the belt reel axis 18 so that webbing 16 can be wound onto the belt reel 14 and unwound from the belt reel 14 by a vehicle occupant at will.

As already illustrated, the belt retractor 10 can be transferred in a vehicle-sensitive or a webbing-sensitive manner to a locking state in which the belt webbing 16 can no longer be unwound from the belt reel 14 at all or only to a limited extent.

In order to bring about such a state, the blocking pawl 48 is initially transferred to its blocking position by means of the actuator 50 so that it engages in the blocking teeth 46 of the clutch disk 38 and, thus, prevents the clutch disk 38 from further rotating in the unwinding direction (cf. arrow 30) (see FIG. 2).

The clutch disk 38 and the locking disk 22 are still in their rotatory initial position, i.e., the clutch disk 38 abuts on the stop 39a of the locking disk 22.

If webbing 16 is continued to be extended from the belt reel 14, the clutch disk 38 remains rotationally blocked vis-à-vis the frame 12.

However, the locking disk 22 rotates.

In other words, a relative rotation takes place between the clutch disk 38 and the locking disk 22.

In this way, the locking slide 24 is moved out of its retracted position in the direction of its extended position.

Said movement occurs by the fact that the control element 36 is moved due to the relative rotation along the control geometry 40 out of the first retraction area 40a in the direction of the first extension area 40b.

Said movement takes place against the bias of the portion 34 of the spring 32.

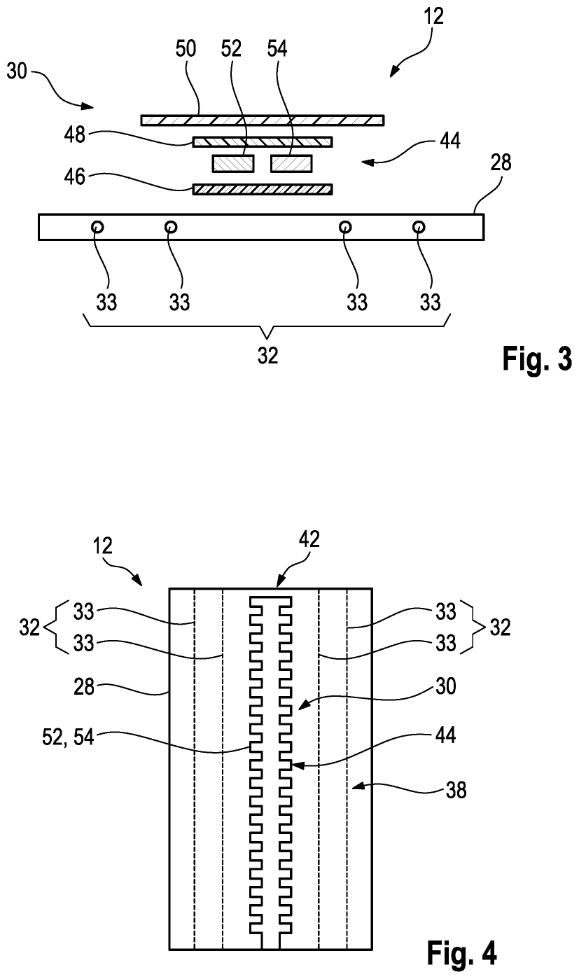

In case that the belt retractor 10 is actuated by very high dynamics, it is possible that its components will elastically deform. This fact is symbolized in FIG. 3 in that the blocking pawl 48 is shown to have a certain overlap relative to an associated tooth of the blocking teeth 46.

This elastic deformation of the components of the belt retractor 10 results in the fact that the locking slide 24, if it assumes its expanded position, does not engage in the actually provided portion of the locking teeth 28 on the frame 12 (cf. dashed representation 24a of the locking slide 24 in FIG. 4), but a tooth-on-tooth position occurs between the locking slide 24 and the locking teeth 28 (see FIG. 4).

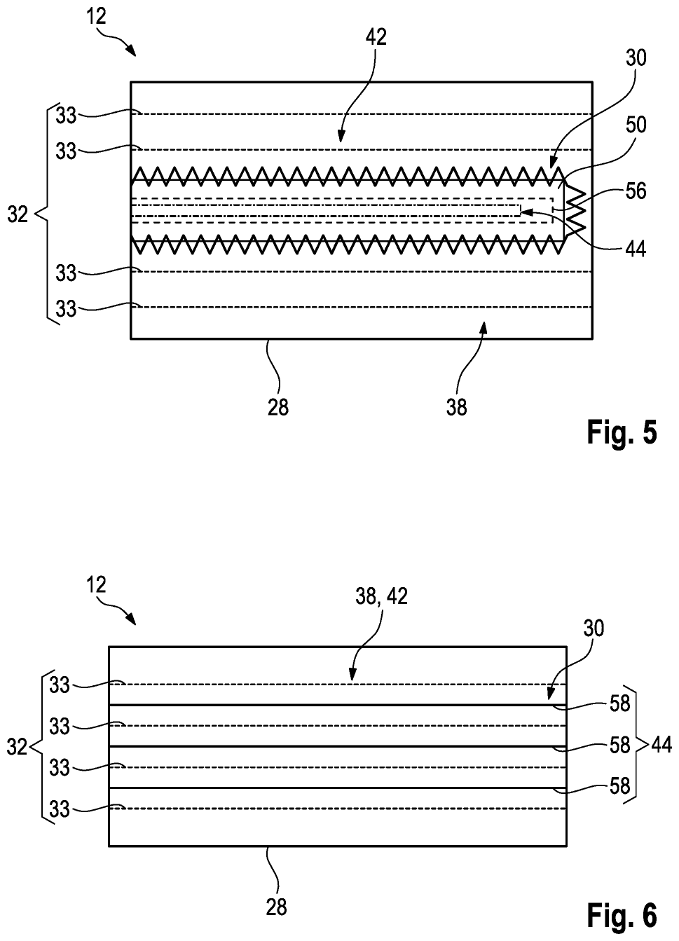

If belt webbing 16 is continued to be unwound from the belt reel 14 and, thus, the locking disk 22 is continued to be rotated relative to the clutch disk 38, the locking slide 24 slides off the tooth with which it formed the tooth-on-tooth position before due to the interaction between the control element 36 and the control geometry 40 (see FIG. 5).

A continued rotation of the locking disk 22 results in the portion 54 of the spring 32 getting in contact with the clutch disk 38 and starting to build up an appropriate bias (see FIG. 6).

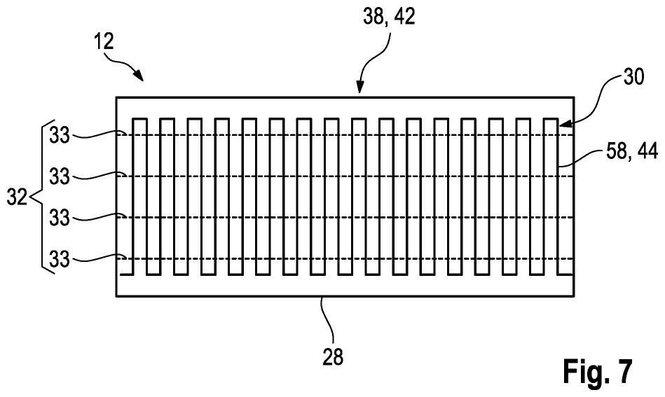

If the locking disk 22 is further rotated relative to the clutch disk 38, said bias is increased and the locking slide 24 finally engages in the locking teeth 28 (see FIG. 7).

In this position, the locking disk 22 and the clutch disk 38 are rotated against each other beyond the predetermined amount due to the already mentioned elastic deformation.

The control element 36 is now in the second extension area 40c of the control geometry 40.

In addition, the clutch disk 38 abuts on the stop 39b of the locking disk 22.

In this situation, the portion 34 of the spring 32 and the portion 54 of the spring 32 are moreover maximally biased.

Since, in this position, the locking slide 24 does not engage in the portion of the locking teeth 28 corresponding to the predefined relative rotation between the clutch disk 38 and the locking disk 22 (cf. dashed representation 24a in FIGS. 4 and 7) but only a tooth pitch offset to this, one speaks of a non-synchronously locked state of the belt retractor 10.

In this position, the locking disk 22 is prevented from further rotating relative to the frame 12.

Alternatively to elastic deformations resulting from a highly dynamic actuation of the belt retractor 10, the non-synchronously locked state of the belt retractor can also result, if its components are provided with play beyond the desired amount due to manufacturing tolerances or aging influences, for example.

In order to free the belt retractor 10 from this position, the belt webbing 16 is let go so that the belt reel 14 rotates in a winding direction (compare arrow 56 and FIG. 8).

During said rotation, the locking slide 24 is applied in the direction of the control geometry by means of the spring 52 or by means of the portion 54 of the spring 32 and is thus moved in the direction of its retracted position.

Moreover, the locking slide 24 slides off the tooth backs of the locking teeth 28.

As a result, the blocking pawl 48 can be shifted relative to the blocking teeth 46 in the direction of its idle position.

If said rotational movement of the locking disk 22 is continued, because of the sliding of the locking slide 24 off the locking teeth 28 and the related rotation of the clutch disk 38, a clearance is formed between the blocking pawl 48 and the associated blocking teeth 46 so that the blocking pawl 48 will be free to move to its idle position (see FIG. 9).

In the shown embodiment, the blocking pawl 48 is subsequently transferred by force of gravity to the idle position (see FIG. 10).

Due to the load by the spring 52 and, resp., the portion 54 of the spring 32 as well as by the portion 34 of the spring 32, the control element 36 is moved to the second retraction area 40d of the control geometry 40. This is moreover accompanied by the locking slide 24 sliding off the locking teeth 28.

This is only possible because the clutch disk 38 is released regarding a rotation about the belt reel axis 18.

If the control element 36 has reached the second retraction area 40d, it has arrived at the end of the control geometry 40. For this reason, the locking slide 24 cannot be moved further in the direction of its retracted position. Thus, the locking disk 22 cannot be moved further in the unwinding direction, either (see FIG. 11).

Now the webbing 16 is loaded in the unwinding direction again.

This causes the locking disk 22 to rotate again in the direction symbolized by the arrow 30 (see FIG. 12).

In this way, the locking slide 24, and more precisely the teeth thereof, are lifted off the tooth backs of the locking teeth 28 and applied to the respective opposite tooth face of the locking teeth 28 (see FIG. 13).

Based on this, the locking disk 22 cannot be rotated further, as the locking slide 24 engages in the locking teeth 28.

However, the control element 36 can slide off the control geometry 40.

At the same time, the locking slide 24 slides more deeply into the locking teeth 28.

Thus, a rotation of the released clutch disk 38 relative to the locking disk 22 is resulting.

Such rotation occurs until the locking slide 24 engages completely in the locking teeth 28 (see FIG. 15).

Due to the reset by means of the spring 52 or the portion 54 of the spring 32, the control element 36 then reaches the first extension area 40b (see FIG. 15).

This state corresponds, regarding the relative rotary position, to the clutch disk 38 and the locking disk 22 and, regarding the position of the locking slide 24, to a synchronously locked state of the belt retractor 10, i.e., a locking state of the belt retractor in which the clutch disk 38 and the locking disk 22 are rotated against each other within a predefined degree. Merely the blocking pawl 48 is in its idle position in contrast to the synchronous locking state.

If the webbing 16 is let go and thus is no longer loaded in the direction of extension, the belt retractor 10 consequently can unlock in the same way as for a synchronous locking.

Due to the restoring force of the spring 32, the control element 36 thus slides off along the control geometry 40 until it reaches the first retraction area 40a.

At the same time, the locking slide 24 is transferred to its retracted position (see FIG. 16).

In this state, the belt retractor 10 is unlocked. Consequently, belt webbing 16 can be wound and unwound.

1-15. (canceled)

16. A belt webbing for a seatbelt system (10) of an automotive vehicle, comprising
a webbing body (28) including a heating portion (38), wherein the heating portion (38) is formed by a heating device (32) disposed on the webbing body (28), and
at least one temperature measuring device (30) disposed on the webbing body (28) in the heating portion (38) by which a temperature can be sensed in the heating portion (38).

17. The belt webbing according to claim 16, wherein the at least one temperature measuring device (30) has a by far smaller thickness than the webbing body (28), the thickness of the temperature measuring device (30) amounting to less than 50%, specifically less than 10%, of the thickness of the webbing body (28).

18. The belt webbing according to claim 16, wherein the at least one temperature measuring device (30) has at least the same flexibility and/or at most the same non-deformability as the webbing body (28).

19. The belt webbing according to claim 16, wherein the heating portion (38) extends in the longitudinal direction of the belt webbing (12), the at least one temperature measuring device (30) extending along the whole length of the heating portion (38).

20. The belt webbing according to claim 16, wherein the heating portion (38) is formed by one or more heating elements (33) extending in the longitudinal and/or transverse direction, at least in portions in parallel to each other, the at least one temperature measuring device (30) extending in parallel to the heating element (33) and/or in parallel between the heating elements (33).

21. The belt webbing according to claim 16, wherein the at least one temperature measuring device (30) comprises a temperature sensor (44) which is woven into the webbing body (28), is bonded, stitched and/or printed onto the webbing body (28), or is bonded, stitched and/or printed onto the webbing body (28) via another component part of the at least one temperature measuring device (30).

22. The belt webbing according to claim 21, wherein the at least one temperature measuring device (30) includes a protective layer (50), the temperature sensor (44) being covered or surrounded by the protective layer (50), and specifically fastened on the webbing body (28) by the protective layer (50).

23. The belt webbing according to claim 21, wherein the temperature sensor (44) is a thermocouple.

24. The belt webbing according to claim 21, wherein the temperature sensor (44) is a resistance thermometer.

25. The belt webbing according to claim 21, wherein the temperature sensor is a coated optical fiber.

26. The belt webbing according to claim 21, wherein the webbing body (28) is woven and includes warp threads extending in the longitudinal direction and weft threads extending transversely to the warp threads, the at least one temperature measuring device (30) being woven as at least one warp thread and/or at least one weft thread into the webbing body (28).

27. The belt webbing according to claim 26, wherein the temperature sensor (44) is a measuring wire.

28. The belt webbing according to claim 16, wherein the temperature sensor (44) is accommodated in a woven-in chamber.

29. A seatbelt system for an automotive vehicle, comprising
a control unit (26), and
a belt webbing (12) according to claim 16, wherein the heating device (32) and the at least one temperature measuring device (30) are coupled with the control unit (26).

30. The seat belt system according to claim 29, wherein the control unit (26) is configured to change, and specifically to control, the temperature in the heating portion (38) on the basis of the temperature sensed in the heating portion (38) by the temperature measuring device (30).
